(19) United States
(12) Patent Application Publication
(10) Pub. No.: US 2025/0126475 A1
(43) Pub. Date: Apr. 17, 2025

(54) OAUTH2 REQUIREMENT PER PLMN TO THE DEFINITION OF TYPE NFSERVICE

(71) Applicant: TELEFONAKTIEBOLAGET LM ERICSSON (PUBL), STOCKHOLM (SE)

(72) Inventors: Songmao Li, SHANGHAI (CN); Christine Jost, DALBY (SE); Jesús Ángel DE GREGORIO RODRIGUEZ, MADRID (ES); Sune Gustafsson, ÖXABÄCK (SE)

(21) Appl. No.: 18/684,530

(22) PCT Filed: Aug. 18, 2022
(86) PCT No.: PCT/IB2022/057765

§ 371 Date: Feb. 16, 2024

(30) Foreign Application Priority Data
Aug. 18, 2021 (WO) PCT/CN2021/113266

(51) Int. Cl. H04W 12/084; H04L 67/51

(52) U.S. Cl. CPC H04W 12/084; H04L 67/51

(57) ABSTRACT

Systems and methods related to authorization in a cellular communications system. In one embodiment, a method performed by a Network Function (NF) comprises sending, to another network function, information that indicates whether a particular type of authorization is required per Public Land Mobile Network (PLMN) for a particular NF service instance associated with the NF. In one embodiment, the other network function is a Network Repository Function (NRF). In one embodiment, the information is comprised in a NF profile of the NF. In one embodiment, the particular type of authorization is Oauth2-based authorization.

### RELATED APPLICATIONS

The present application claims priority to and the benefit of PCT/CN2021/113266 filed Aug. 18, 2021, the disclosure of which is hereby incorporated herein by reference in its entirety.

### TECHNICAL FIELD

The present disclosure relates to a cellular communications system and, more specifically, to authorization in a cellular communications system.

### BACKGROUND

In Third Generation Partnership Project (3GPP) Technical Specification (TS) 33.501 V17.2.1 “Security architecture and procedures for 5G system” clauses 13.3 and 13.4, there are two types of authorization defined. One of the defined types of authorization is static authorization, and the other defined type of authorization is OAuth2.0 token-based authorization.

Static authorization is based on local authorization policy at the Network Repository Function (NRF) and the Network Function (NF) Service Producer. Static authorization can be used when token-based authorization is not used. When static authorization is used within one Public Land Mobile Network (PLMN) and the NF Service Producer receives a service request, the NF Service Producer shall check authorization of the NF Service Consumer based on its local policy. If the NF Service Consumer is authorized to receive the service requested, the NF Service Producer shall grant the NF Service Consumer access to the service Application Programming Interface (API).

The token-based authorization framework uses the OAuth 2.0 framework as specified in RFC 6749. The OAuth2.0 token-based authorization allows NF Service Producers to authorize the requests from NF Service requestors based on access token. The NF Service Consumer shall request an access token from the NRF before NF Service access. If the NF Service Consumer is authorized, the NRF shall then generate an access token with appropriate claims included. The NF Service Consumer shall include the access token when the NF Service Consumer requests service from the NF Service Producer. The NF Service Producer shall verify the token. If the verification is successful, the NF Service Producer shall execute the requested service and respond back to the NF Service Consumer. Otherwise, the NF Service Producer shall reply based on OAuth2.0 error response defined in RFC 6749.

In 3GPP TS 29.510 V17.2.0 “5G System; Network Function Repository Services; Stage 3” clause 6.1.6.2.3, Type: NFService is defined where the NFService type includes an attribute oauth2Required. The attribute oauth2Required is defined to indicate whether the NF Service Instance requires Oauth2-based authorization.

### SUMMARY

Systems and methods related to authorization in a cellular communications system. In one embodiment, a method performed by a Network Function (NF) comprises sending, to another network function, information that indicates whether a particular type of authorization is required per Public Land Mobile Network (PLMN) for a particular NF service instance associated to the NF. In one embodiment, the other network function is a Network Repository Function (NRF).

In one embodiment, the information is comprised in a NF profile of the NF.

In one embodiment, the information is comprised in a NF Service object that is comprised in a NF profile of the NF. In one embodiment, sending the information comprises sending a NF profile of the NF to the other network node, wherein the NF profile comprises a list of NF Service objects for respective NF service instances associated to the NF and the information is comprised in the NF Service object for the particular NF service instance. In one embodiment, the information is comprised in a new attribute of the NF Service object, where the new attribute indicates whether the particular NF service instance requires Oauth2-based authorization per consumer PLMN ID and/or producer PLMN ID.

In one embodiment, the particular type of authorization is Oauth2-based authorization.

In one embodiment, the method further comprises receiving, from a NF service consumer, a service request for the particular NF service instance and determining which of two or more authorization mechanisms to use for the NF service consumer based on the information that indicates whether the particular type of authorization is required per PLMN for the particular NF service instance and one or more relevant PLMN IDs. In one embodiment, the one or more relevant PLMN IDs comprise a PLMN ID of a PLMN of the NF service consumer and/or a PLMN ID of a PLMN of the particular NF service instance. In one embodiment, the method further comprises proceeding with processing the service request based on the determined authorization mechanism.

In another embodiment, a method performed by a NF comprises receiving, from another network function, information that indicates whether a particular type of authorization is required per PLMN for a particular NF service instance associated to the other NF. In one embodiment, the NF is an NRF.

In one embodiment, the information is comprised in a NF profile of the other NF. In one embodiment, the information is comprised in a NF Service object that is comprised in a NF profile of the other NF.

In one embodiment, receiving the information comprises receiving a NF profile of the other NF from the other network node, wherein the NF profile comprises a list of NF Service objects for respective NF service instances associated to the other NF and the information is comprised in the NF Service object for the particular NF service instance. In one embodiment, the method further comprises storing the NF profile.

In one embodiment, the information is comprised in a new attribute of the NF Service object, where the new attribute indicates whether the particular NF service instance requires Oauth2-based authorization per consumer PLMN ID and/or producer PLMN ID.

In one embodiment, the particular type of authorization is Oauth2-based authorization.

In one embodiment, the method further comprises storing the information.

In one embodiment, the method further comprises receiving a discovery request from a NF service consumer, determining that the particular NF service instance satisfies the discovery request, determining a particular authorization requirement for the NF service consumer based on the information that indicates whether the particular type of authorization is required per PLMN for the particular NF service instance and one or more relevant PLMN IDs, and sending a discovery response to the NF service consumer, wherein the discovery response comprises information that indicates the particular authorization requirement for the NF service consumer.

Embodiments of a network node are also disclosed herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system according to some embodiments of the present disclosure;

FIGS. 2 and 3 illustrate example embodiments in which the cellular communication system of FIG. 1 is a Fifth Generation (5G) System (5GS);

FIG. 4 illustrates one example of a NF registration procedure in accordance with one embodiment of the present disclosure;

FIG. 5 illustrates one example of a NF discovery procedure in accordance with one embodiment of the present disclosure;

FIG. 6 illustrates one example of a NF service request procedure in accordance with one embodiment of the present disclosure;

FIG. 7 is a schematic block diagram of a network node according to some embodiments of the present disclosure;

FIG. 8 is a schematic block diagram that illustrates a virtualized embodiment of the network node of FIG. 7 according to some embodiments of the present disclosure; and

FIG. 9 is a schematic block diagram of the network node of FIG. 7 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). A roaming Network Function (NF) service consumer in a serving Public Land Mobile Network (PLMN) and a non-roaming NF service consumer in a home PLMN may use different authorization mechanisms, but when they want to consume the same NF service producer in home PLMN, there will be an interoperability issue since the NF service producer may require one authorization mechanism, which may be different than the authorization mechanism supported/used by the roaming NF service consumer. And NF service producer will generate error signaling to inform NF service consumer about the failure details. In case that roaming NF service consumer support but does not use required authorization mechanism, NF service consumer can act accordingly by switching to the required authorization mechanism to continue the interworking. And in case that roaming NF service consumer does not support required authorization mechanism, the interworking will fail.

Certain aspects of the disclosure and their embodiments may provide solutions to these or other challenges. Systems and methods are disclosed herein that provide different OAuth2 requirements for different PLMN separately, e.g., in the definition of type NFService described in 3GPP TS 29.510 V17.2.0 Table 6.1.6.2.3-1. This will improve the interoperability between different PLMNs.

In one embodiment, if OAuth2 requirement is different for NF service consumers in different PLMNs (i.e., having different PLMN IDs), the NF service producer indicates OAuth2 requirements for roaming NF service consumer and non-roaming NF service consumer separately (e.g., different OAuth2 requirements for different consumer PLMN IDs) during NF service registration.

In another embodiment, if OAuth2 requirement is different for NF service producer (instances) in different home PLMNs (i.e., having different PLMN IDs), the NF service producer indicates OAuth2 requirement for different producer PLMNs separately during NF service registration.

In another embodiment, if OAuth2 requirement is different for different combinations of consumer and producer PLMN IDs, the NF service producer indicates OAuth2 requirements for the different combinations of consumer and producer PLMN IDs separately during NF service registration.

In one embodiment, the NRF and the NF service producer may distinguish between a roaming NF service consumer and non-roaming NF service consumer. In other words, the NRF and/or NF service producer may determine whether a particular discovery or service request is from a roaming NF service consumer or a non-roaming NF service consumer, e.g., by checking consumerPlmnId in a respective access token or by checking 3gpp-Sbi-Asserted-Plmn-Id header in the request.

In one embodiment, the NRF may get the producer PLMN ID of the expected NF service producer instance by checking target-plmn-list in the NF discovery request.

In one embodiment, the NRF determines the OAuth2 requirement for the NF service consumer at the receipt of a NF discovery request from the NF service consumer. The NRF checks the registered OAuth2 requirements of the expected NF service producer instance (i.e., the NF service producer instance to be indicated in the discovery response), together with the knowledge of the consumer PLMN ID (i.e., the PLMN ID of the PLMN of the NF service consumer) and the producer PLMN ID (i.e., the PLMN ID of the PLMN of the expected NF service producer instance), determines the exact OAuth2 requirement for the NF service consumer, and returns an indication of the exact OAuth2 requirement for the NF service consume, e.g., via the existing IE oauth2Required, to the NF service consumer.

In one embodiment, the NF service producer determines the OAuth2 requirement for the NF service consumer at the receipt of service request. The NF service producer checks the local configured OAuth2 requirements (which are also registered in NRF), together with the knowledge of consumer PLMN ID and/or producer PLMN ID, and determines the exact OAuth2 requirement for the NF service consumer, and performs the authorization verification accordingly.

In one embodiment, a new optional attribute is introduced to the existing definition of type NFService, where this new attribute is defined to indicate OAuth2 requirement per PLMN ID.

Certain embodiments may provide one or more of the following technical advantage(s). For example, embodiments disclosed herein may improve the interoperation between different PLMNs which use different authorization mechanisms.

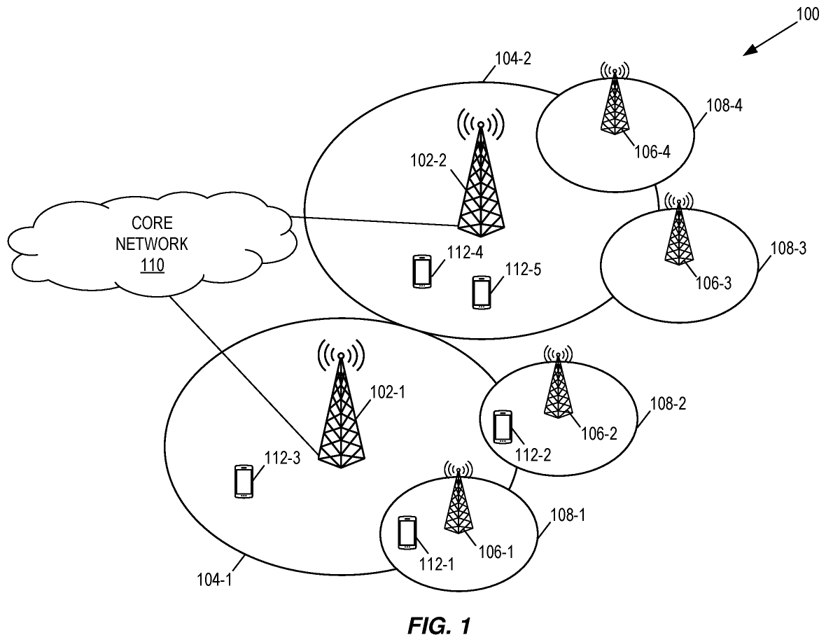

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC); however, the present disclosure is not limited thereto. In this example, the RAN includes base stations 102-1 and 102-2, which in the 5GS include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

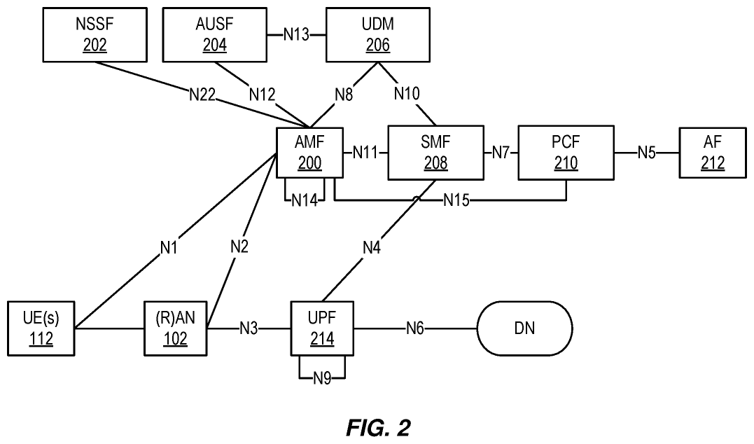

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 1.

Seen from the access side the 5G network architecture shown in FIG. 2 comprises a plurality of UEs 112 connected to either a RAN 102 or an Access Network (AN) as well as an AMF 200. Typically, the R (AN) 102 comprises base stations, e.g. such as eNBs or gNBs or similar. Seen from the core network side, the 5GC NFs shown in FIG. 2 include a NSSF 202, an AUSF 204, a UDM 206, the AMF 200, a SMF 208, a PCF 210, and an Application Function (AF) 212.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208.

The 5GC network aims at separating UP and CP. The UP carries user traffic while the CP carries signaling in the network. In FIG. 2, the UPF 214 is in the UP and all other NFs, i.e., the AMF 200, SMF 208, PCF 210, AF 212, NSSF 202, AUSF 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

FIG. 3 illustrates a 5G network architecture using service-based interfaces between the NFs in the CP, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF 200 and Nsmf for the service based interface of the SMF 208, etc. The NEF 300 and the NRF 302 in FIG. 3 are not shown in FIG. 2 discussed above. However, it should be clarified that all NFs depicted in FIG. 2 can interact with the NEF 300 and the NRF 302 of FIG. 3 as necessary, though not explicitly indicated in FIG. 2.

Some properties of the NFs shown in FIGS. 2 and 3 may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF 208 operate properly. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

In one embodiment, a new (optional) attributed is added to the definition of type NFService defined in 3GPP TS 29.510 Table 6.1.6.2.3-1. This new attribute is referred to herein as oauth2RequiredPerPlmn; however, this name for the attribute is only an example. Other names for the new attribute may be used.

TABLE 1
Modified version of 3GPP TS 29.510 Table 6.1.6.2.3-1: Definition of type NFService
NOTE: For simplicity, all not relevant attributes in the Table 6.1.6.2.3-1 are removed.

| Attribute name | Data type | P | Cardinality | Description |
|---|---|---|---|---|
| oauth2Required | boolean | O | 0 . . . 1 | It indicates whether the NF Service |
| | | | | Instance requires Oauth2-based |
| | | | | authorization. |
| | | | | Absence of this IE means that the NF |
| | | | | Service Producer has not provided any |
| | | | | indication about its usage of Oauth2 for |
| | | | | authorization. |
| oauth2RequiredPerPlmn | array(Oauth2ReqPerPlmn) | O | 1 . . . N | It indicates whether the NF Service |
| | | | | Instance requires Oauth2-based |
| | | | | authorization per consumer PLMN ID |
| | | | | and/or producer PLMN ID. |
| | | | | This IE may be included when the Oauth2- |
| | | | | based authorization required by the NF |
| | | | | Service for each PLMN ID that consumer |
| | | | | belongs to is different, or when the Oauth2- |
| | | | | based authorization required by the NF |
| | | | | Service for each PLMN ID it is supporting |
| | | | | is different. |
| | | | | When present, this IE shall include the |
| | | | | requirement of Oauth2-based authorization |
| | | | | by the NF Service for each PLMN ID and |
| | | | | it shall prevail over the oauth2Required by |
| | | | | the NF service instance for indicated |
| | | | | PLMN ID(s). |

In one embodiment, the new attribute (oauth2RequiredPerPlmn) in the definition of type NFService can be defined as array data type or map data type, to indicate whether the NF Service Instance requires Oauth2-based authorization per consumer PLMN ID and/or producer PLMN ID.

In one embodiment, during NF service registration, an NF service producer indicates oauth2RequiredPerPlmn if the OAuth2 requirement is different for different consumer PLMN IDs, is different for different producer PLMN IDs, or is different for different combinations of consumer PLMN ID and producer PLMN ID.

In one embodiment, NRF and NF service producer may distinguish roaming NF service consumer or non-roaming NF service consumer, e.g., by checking consumerPlmnId in access token or 3gpp-Sbi-Asserted-Plmn-Id header in the request.

In one embodiment, NRF may get the producer PLMN ID of the expected NF service producer instance by checking target-plmn-list in the NF discovery request.

In one embodiment, NRF determines the OAuth2 requirement for the NF service consumer at the receipt of NF discovery request. The NRF checks the registered OAuth2 requirements of the expected NF service producer instance, together with the knowledge of consumer PLMN ID and producer PLMN ID, and determines the exact OAuth2 requirement for the NF service consumer, and returns it via existing IE oauth2Required to the NF service consumer.

In one embodiment, when an NF service consumer in the serving PLMN receives a Nnrf_NFDiscovery_Response with oAuth2Req IE, the NF service consumer uses the required authorization mechanism accordingly when accessing the desired NF service instance.

In one embodiment, NF service producer determines the OAuth2 requirement for the NF service consumer at the receipt of a service request. NF service producer checks the local configured OAuth2 requirements (which are also registered in NRF), together with the knowledge of consumer PLMN ID and/or producer PLMN ID, and determines the exact OAuth2 requirement for the NF service consumer, and performs the authorization verification accordingly.

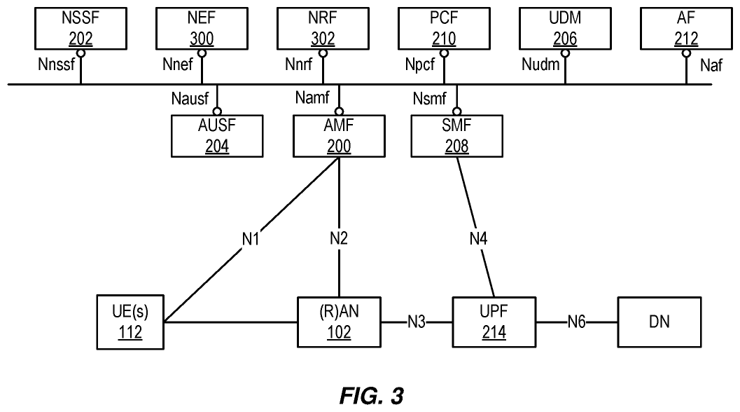

FIG. 4 illustrates the operation of a NF 400 and a Network Repository Function (NRF) 402 for NF registration in accordance with one example embodiment of the present disclosure. In this context, the NF 400 may also be referred to as a NF service producer of the registration service of the NRF 402. However, the NF 400 can also be a NF service producer with respect to the NF services indicated in the NF profile of the NF 400. As illustrated, the NF 400 sends a PUT request to the NRF 402, where the PUT request includes an NF instance ID of the NF 400 and a NF Profile of the NF 400 (step 404). As described in 3GPP TS 23.510 V17.2.0 clause 6.1.6.2.2, the NF profile of the NF 400 includes many attributes including the NF Instance ID, NF type, a list NF Services (nfServiceList), etc. The array or list of NF Services attributes is a list or array of NFService objects. As defined in 3GPP TS 23.510 V17.2.0 clause 6.1.6.2.3, the NFService object includes a NF service instance ID (“serviceInstanceId”) of the respective NF service instance, an oauth2required attribute, and many other attributes. The oauth2required attribute in the current definition of the NF Service type indicates whether the NF Service Instance requires Oauth2-based authorization. In addition, in accordance with one embodiment of the present disclosure, the NFService object further includes a new attribute (oauth2RequiredPerPlmn) indicates whether the NF Service Instance requires Oauth2-based authorization per consumer PLMN ID and/or producer PLMN ID, as described above. The NRF 402 stores the NF profile of the NF 400 (step 406).

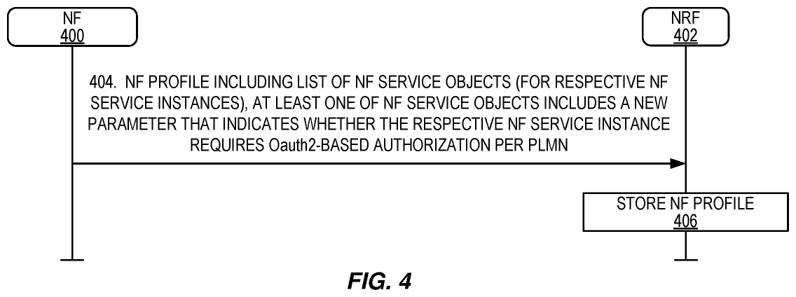

FIG. 5 illustrates the operation of a NF service consumer 500 and a NRF 402 to perform a NF discovery procedure in accordance with one embodiment of the present disclosure. As illustrated, the NF service consumer 500 sends a NF discovery request (Nnrf_NFDiscovery_Request) to the NRF 402 (step 502). The NRF 402 determines that a particular NF service instance of the NF 400 satisfies the discovery request (step 504). Note that, in this context, the NF 400 is also referred to as a NF service producer 400. The NRF 402 determines a particular OAuth2 requirement for the NF service consumer 500 to access the NF service of the particular NF service instance, considering the relevant PLMN ID(s) (i.e., the consumer PLMN ID and/or the producer PLMN ID) (step 506). More specifically, in one embodiment, the NRF 402 obtains the relevant PLMN IDs (i.e., the consumer PLMN ID of the NF service consumer 500 and/or the producer PLMN ID of the particular NF service instance that satisfies the discovery request) (step 506A). The NRF 402 then determines the particular OAuth2 requirement based on the information stored in the oauth2RequiredPerPlmn attribute of the NFService object for the particular NF service instance in the NF Profile of the NF service producer 400 and the relevant PLMN ID(s) (step 506B). The NRF 402 sends a NF discovery response (Nnrf_NFDiscovery_Response) to the NF service consumer 500 (step 508). The NF discovery response includes information that indicates the determined, particular OAuth2 requirement for the NF service consumer 500. In one embodiment, the determined, particular OAuth2 requirement is sent to the NF service consumer 500 via the existing IE oauth2Required attribute.

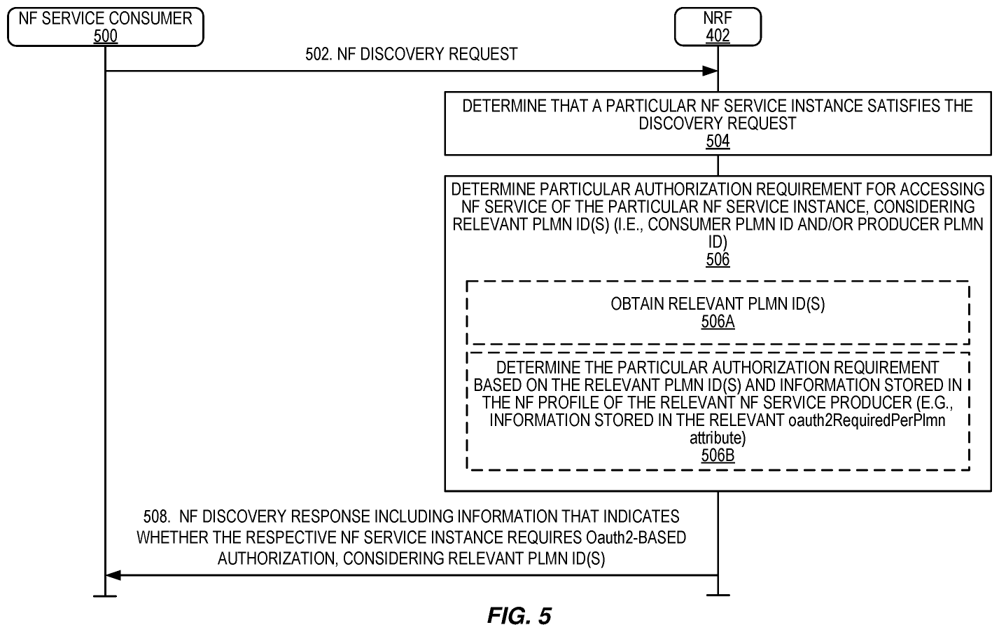

FIG. 6 illustrates the operation of a NF service consumer 600 and a NF server producer 602 (e.g., the NF service producer in the home PLMN) in accordance with one embodiment of the present disclosure. As illustrated, the NF service consumer 600 determines an authorization mechanism to be used when accessing a service provided by a particular NF service instance of the NF service producer 602 (step 604). In one embodiment, the NF service consumer 600 determines the authorization mechanism to be used based on the authorization requirement received by the NF service consumer 600 from the NRF (e.g., via the procedure of FIG. 5). The NF service consumer 600 then sends a service request to the NF service instance of the NF service producer 602 using the determined authorization mechanism (step 606).

In one embodiment, the NF service producer 602 obtains the PLMN ID of the PLMN of the NF consumer 600 (step 608). The consumer PLMN ID may be obtained, e.g., either from consumerPlmnId in a respective access token or from a 3gpp-Sbi-Asserted-Plmn-Id header in the service request. The NF service producer 602 may then use the consumer PLMN ID, its own home PLMN ID, and the information included in the auth2RequiredPerPlmn attribute for the respective NF service instance to determine the authorization mechanism to be used with respect to access to the requested service by the NF service consumer 600 (step 610). The NF service producer 602 then proceeds accordingly (step 612). For example, if OAuth2.0 token-based authorization is determined to be used, the NF Service Producer 602 authorizes the service request from the NF Service consumer 600 based on the access token. Note that the NF Service Consumer 600 requests an access token from the NRF before the NF Service access. If the NF Service Consumer 600 is authorized, the NRF then generates the access token with appropriate claims included. The NF Service Consumer 600 includes the access token when sending the service request to the NF Service Producer 602. The NF Service Producer 602 verifies the token. If the verification is successful, the NF Service Producer 602 executes the requested service and responds back to the NF Service Consumer 600. Otherwise, it replies based on OAuth 2.0 error response defined in RFC 6749. Conversely, if OAuth2.0 token-based authorization is determined not to be used, static authorization may be used by NF Service Producer 602. At the receipt of the service request, the NF Service Producer 602 checks authorization of the NF Service Consumer 600 based on its local policy. If the NF Service Consumer 600 is authorized to receive the service requested, the NF Service Producer 602 grants the NF Service Consumer 600 access to the service API, otherwise it rejects the service request.

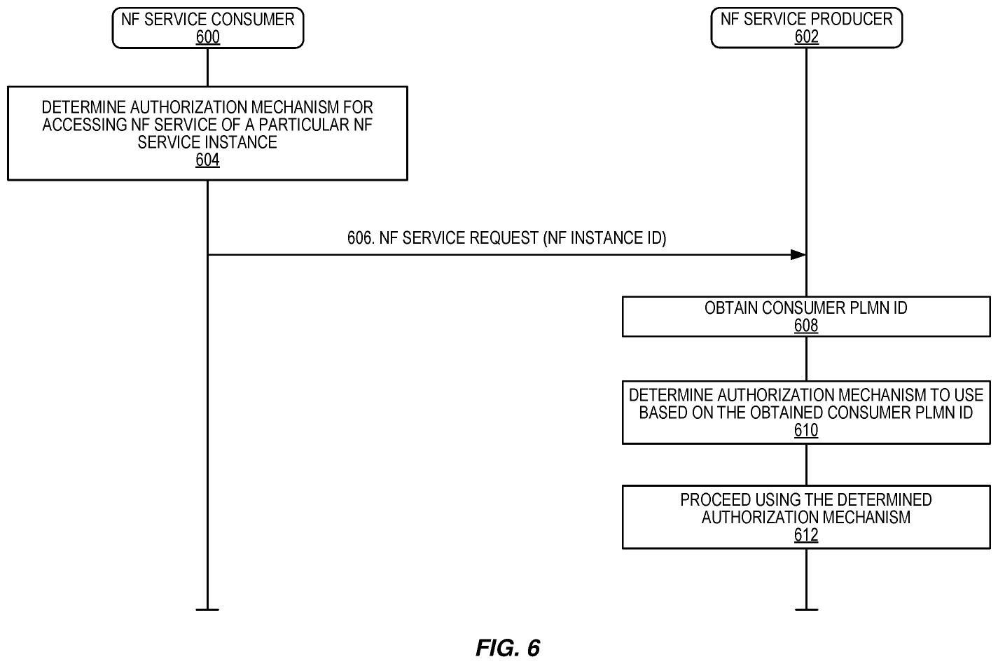

FIG. 7 is a schematic block diagram of a network node 700 according to some embodiments of the present disclosure. Optional features are represented by dashed boxes. The network node 700 may be, for example, a base station 102 or 106 or a network node that implements all or part of the functionality of the base station 102 or gNB described herein. As illustrated, the network node 700 includes a control system 702 that includes one or more processors 704 (e.g., Central Processing Units (CPUs), Application Specific Integrated Circuits (ASICs), Field Programmable Gate Arrays (FPGAs), and/or the like), memory 706, and a network interface 708. The one or more processors 704 are also referred to herein as processing circuitry. In addition, if the network node 700 is a radio access node (e.g., a base station 102, gNB, or network node that implements at least some of the functionality of the base station 102 or gNB), the network node 700 may include one or more radio units 710 that each includes one or more transmitters 712 and one or more receivers 714 coupled to one or more antennas 716. The radio units 710 may be referred to or be part of radio interface circuitry. In some embodiments, the radio unit(s) 710 is external to the control system 702 and connected to the control system 702 via, e.g., a wired connection (e.g., an optical cable). However, in some other embodiments, the radio unit(s) 710 and potentially the antenna(s) 716 are integrated together with the control system 702. The one or more processors 704 operate to provide one or more functions of the network node 700 as described herein (e.g., one or more functions of a base station 102 or gNB described herein). In some embodiments, the function(s) are implemented in software that is stored, e.g., in the memory 706 and executed by the one or more processors 704.

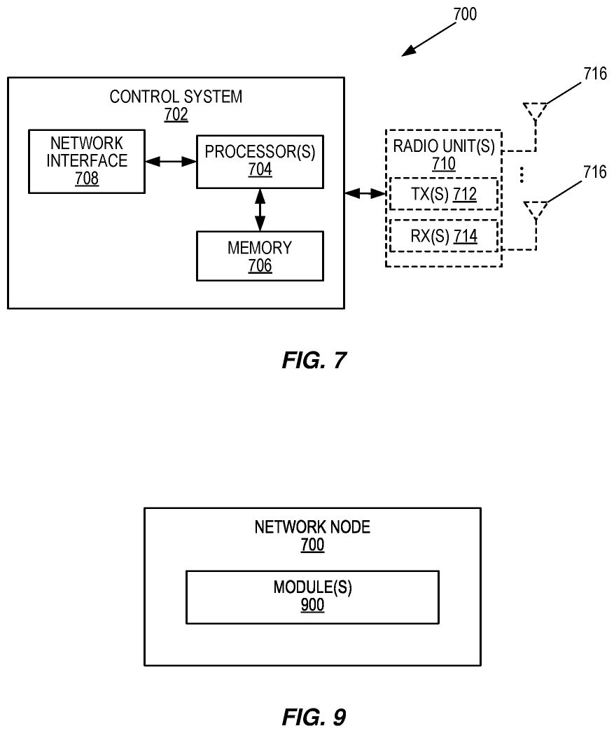

FIG. 8 is a schematic block diagram that illustrates a virtualized embodiment of the network node 700 according to some embodiments of the present disclosure. Again, optional features are represented by dashed boxes. As used herein, a “virtualized” network node is an implementation of the network node 700 in which at least a portion of the functionality of the network node 700 is implemented as a virtual component(s) (e.g., via a virtual machine(s) executing on a physical processing node(s) in a network(s)). As illustrated, in this example, if the network node 700 is a radio access node, the network node 700 may include the control system 702 and/or the one or more radio units 710, as described above. The control system 702 may be connected to the radio unit(s) 710 via, for example, an optical cable or the like. The network node 700 includes one or more processing nodes 800 coupled to or included as part of a network(s) 802. If present, the control system 702 or the radio unit(s) are connected to the processing node(s) 800 via the network 802. Each processing node 800 includes one or more processors 804 (e.g., CPUs, ASICs, FPGAs, and/or the like), memory 806, and a network interface 808.

In this example, functions 810 of the network node 700 described herein (e.g., one or more functions of a base station 102 or gNB described herein) are implemented at the one or more processing nodes 800 or distributed across the one or more processing nodes 800 and the control system 702 and/or the radio unit(s) 710 in any desired manner. In some particular embodiments, some or all of the functions 810 of the network node 700 described herein are implemented as virtual components executed by one or more virtual machines implemented in a virtual environment(s) hosted by the processing node(s) 800. As will be appreciated by one of ordinary skill in the art, additional signaling or communication between the processing node(s) 800 and the control system 702 is used in order to carry out at least some of the desired functions 810. Notably, in some embodiments, the control system 702 may not be included, in which case the radio unit(s) 710 communicate directly with the processing node(s) 800 via an appropriate network interface(s).

In some embodiments, a computer program including instructions which, when executed by at least one processor, causes the at least one processor to carry out the functionality of the network node 700 or a node (e.g., a processing node 800) implementing one or more of the functions 810 of the network node 700 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

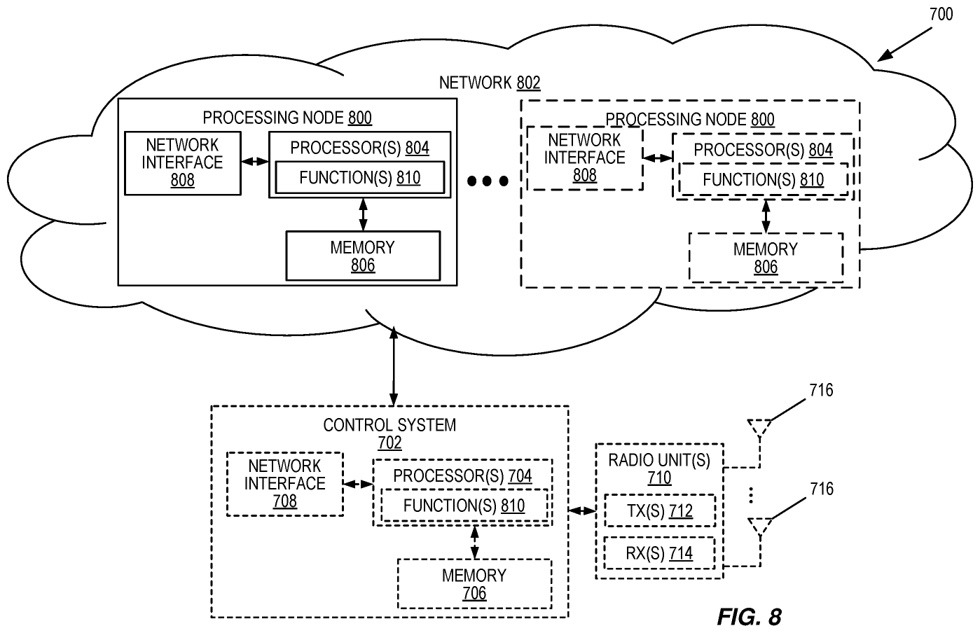

FIG. 9 is a schematic block diagram of the network node 700 according to some other embodiments of the present disclosure. The network node 700 includes one or more modules 900, each of which is implemented in software. The module(s) 900 provide the functionality of the network node 700 described herein. This discussion is equally applicable to the processing node 800 of FIG. 8 where the modules 900 may be implemented at one of the processing nodes 800 or distributed across multiple processing nodes 800 and/or distributed across the processing node(s) 800 and the control system 702.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a Network Function, NF, comprising:
sending, to another network function, information that indicates whether a particular type of authorization is required per Public Land Mobile Network, PLMN, for a particular NF service instance associated with the NF.

2. The method of claim 1 wherein the other network function is a Network Repository Function, NRF.

3. The method of claim 1 wherein the information is comprised in a NF profile of the NF.

4. The method of claim 1 wherein the information is comprised in a NF Service object that is comprised in a NF profile of the NF.

5. The method of claim 1 wherein sending the information comprises sending a NF profile of the NF to the other network node, wherein the NF profile comprises a list of NF Service objects for respective NF service instances associated with the NF and the information is comprised in the NF Service object for the particular NF service instance.

6. The method of claim 4 wherein the information is comprised in a new attribute of the NF Service object, where the new attribute indicates whether the particular NF service instance requires Oauth2-based authorization per consumer PLMN ID and/or producer PLMN ID.

7. The method of claim 1 wherein the particular type of authorization is Oauth2-based authorization.

8. The method of claim 1 further comprising:
receiving, from a NF service consumer, a service request for the particular NF service instance;
determining which of two or more authorization mechanisms to use for the NF service consumer based on the information that indicates whether the particular type of authorization is required per PLMN for the particular NF service instance and one or more relevant PLMN IDs.

9. The method of claim 8 wherein the one or more relevant PLMN IDs comprise a PLMN ID of a PLMN of the NF service consumer and/or a PLMN ID of a PLMN of the particular NF service instance.

10. The method of claim 8 further comprising proceeding with processing the service request based on the determined authorization mechanism.

11. A method performed by a Network Function, NF, comprising:
receiving, from another network function, information that indicates whether a particular type of authorization is required per Public Land Mobile Network, PLMN, for a particular NF service instance associated with the other NF.

12. The method of claim 11 wherein the network function is a Network Repository Function, NRF.

13. The method of claim 11 wherein the information is comprised in a NF profile of the other NF.

14. The method of claim 11 wherein the information is comprised in a NF Service object that is comprised in a NF profile of the other NF.

15. The method of claim 11 wherein receiving the information comprises receiving a NF profile of the other NF from the other network node, wherein the NF profile comprises a list of NF Service objects for respective NF service instances associated with the other NF and the information is comprised in the NF Service object for the particular NF service instance.

16. The method of claim 15 further comprising storing the NF profile.

17. The method of claim 14, wherein the information is comprised in a new attribute of the NF Service object, where the new attribute indicates whether the particular NF service instance requires Oauth2-based authorization per consumer PLMN ID and/or producer PLMN ID.

18. The method of claim 11, wherein the particular type of authorization is Oauth2-based authorization.

19. The method of claim 11, further comprising storing the information.

20. The method of claim 11, further comprising:
receiving a discovery request from a NF service consumer;
determining that the particular NF service instance satisfies the discovery request;
determining a particular authorization requirement for the NF service consumer based on the information that indicates whether the particular type of authorization is required per PLMN for the particular NF service instance and one or more relevant PLMN IDs; and
sending a discovery response to the NF service consumer;
wherein the discovery response comprises information that indicates the particular authorization requirement for the NF service consumer.

21. (canceled)
